(19) United States
(12) Patent Application Publication
(10) Pub. No.: US 2026/0051647 A1
(43) Pub. Date: Feb. 19, 2026

(54) ELECTRONIC DEVICE

(71) Applicant: PEGATRON CORPORATION, TAIPEI CITY (TW)

(72) Inventors: Chien-Yi Wu, Taipei City (TW); Hau Yuen Tan, Taipei City (TW); Chi-Yin Fang, Taipei City (TW); Chih-Wei Liao, Taipei City (TW); Chao-Hsu Wu, Taipei City (TW)

(73) Assignee: PEGATRON CORPORATION, TAIPEI CITY (TW)

(21) Appl. No.: 19/212,730

(22) Filed: May 20, 2025

(30) Foreign Application Priority Data
Aug. 16, 2024 (TW) 113130991

(51) Int. Cl. H01Q 1/22; H01Q 5/30; H04R 1/02

(52) U.S. Cl. CPC H01Q 1/2258; H01Q 5/30; H04R 1/028

(57) ABSTRACT

An electronic device includes an antenna module. The antenna module includes a metal cavity and a feeder. The metal cavity includes a first long side surface and a second long side surface opposite to each other, a first short side surface and a second short side surface opposite to each other, an internal space and a long opening connecting the internal space and close to the second long side surface. The feeder is located in the internal space and apart from the metal cavity. The feeder is located between the first short side surface and the second short side surface, and the feeder is away from the long opening. The antenna module resonates at a low-frequency band and a high-frequency band.

### CROSS-REFERENCE TO RELATED APPLICATION

This application claims the priority benefit of Taiwan application serial no. 113130991, filed on Aug. 16, 2024. The entirety of the above-mentioned patent application is hereby incorporated by reference herein and made a part of this specification.

### BACKGROUND

### Technical Field

The present disclosure relates to an electronic device, and particularly relates to an electronic device having an antenna module.

### Related Art

With the advancement of technology, how to improve the antenna performance of the antenna module in narrow-bezel electronic devices has become a research direction in this field.

### SUMMARY

The present disclosure provides an electronic device, wherein the energy of its antenna module may be concentrated to radiate in a specific direction, thereby having good antenna performance.

An electronic device of the present disclosure includes an antenna module. The antenna module includes a metal cavity and a feeder. The metal cavity includes a first long side surface and a second long side surface opposite to each other, a first short side surface and a second short side surface opposite to each other, an internal space, and a long opening communicating with the internal space and close to the second long side surface. The feeder is located in the internal space and apart from the metal cavity, the feeder is located between the first short side surface and the second short side surface, and the feeder is away from the long opening, the antenna module resonates at a low frequency band and a high frequency band.

Based on the above, such a design not only allows the antenna module to resonate at the low frequency band and the high frequency band, but also enables the energy of the antenna module to transmit from the long opening and may be concentrated to radiate in a specific direction, thereby having good antenna performance.

### BRIEF DESCRIPTION OF THE DRAWINGS

FIG. 1 is a schematic view showing an appearance of an antenna module according to an example of the present disclosure.

FIG. 2 is a perspective view of FIG. 1.

FIG. 3 is a schematic view showing a partial section of an electronic device according to an example of the present disclosure.

FIG. 4 is a relationship diagram of frequency-VSWR of the electronic device of FIG. 3.

FIG. 5 is a relationship diagram of frequency-antenna efficiency of the electronic device of FIG. 3.

### DESCRIPTION OF THE EMBODIMENTS

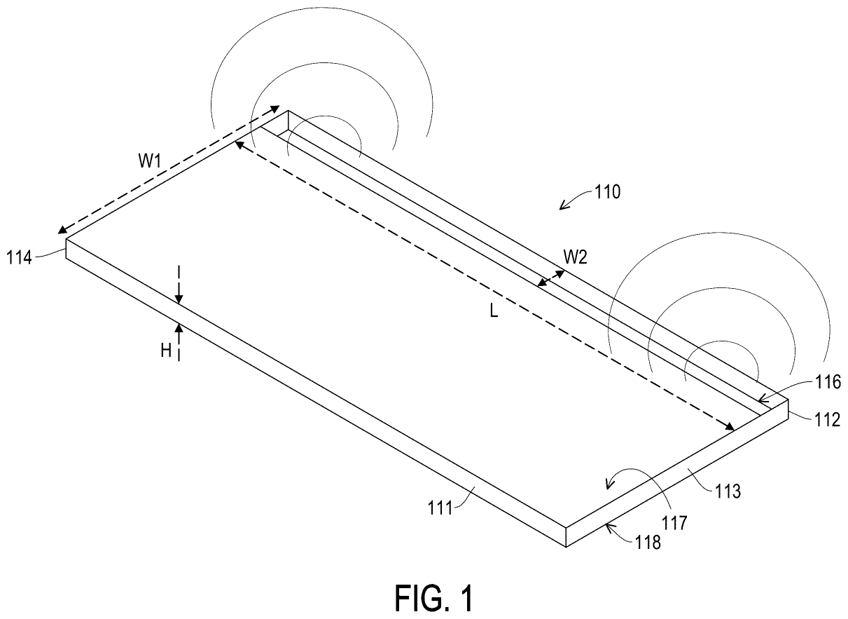

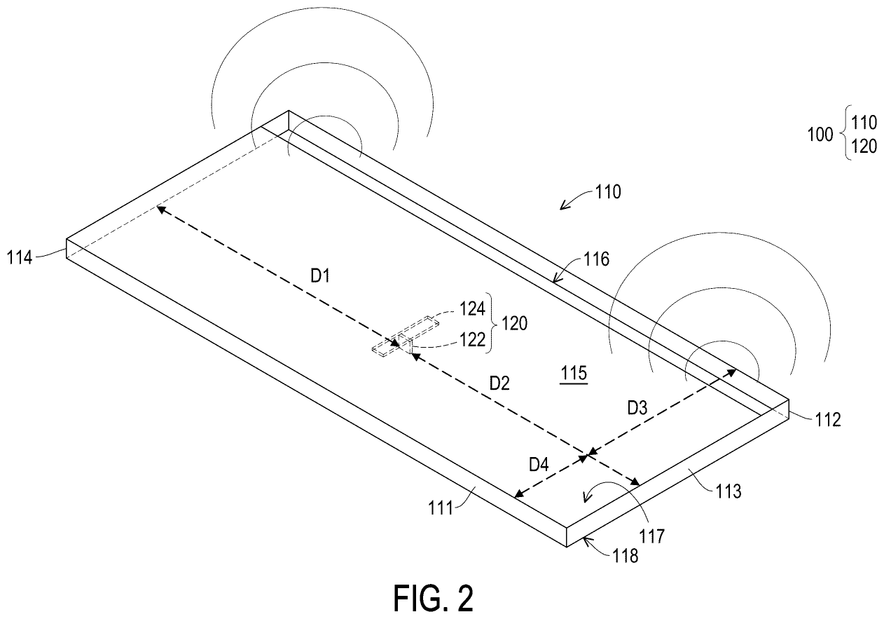

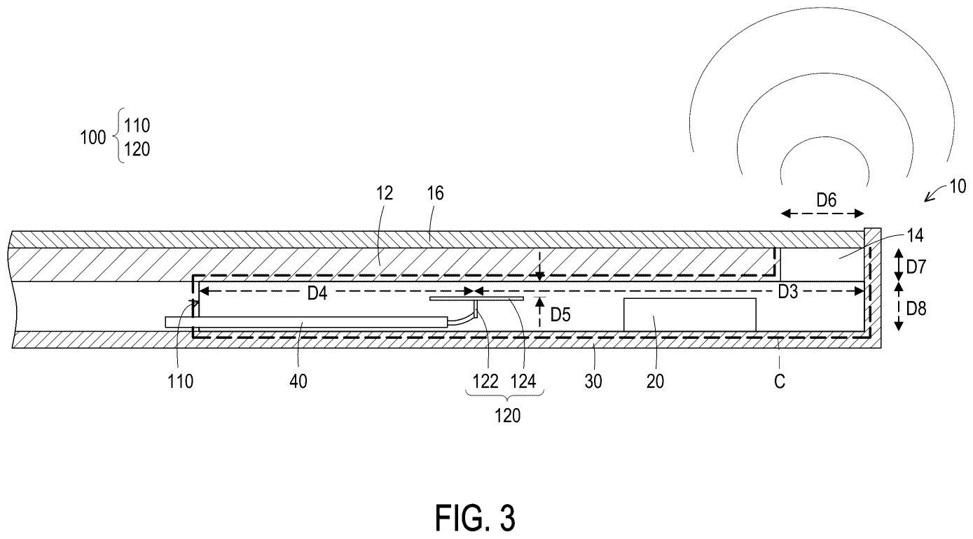

FIG. 1 is a schematic view showing an appearance of an antenna module according to an example of the present disclosure. FIG. 2 is a perspective view of FIG. 1. FIG. 3 is a schematic view showing a partial section of an electronic device according to an example of the present disclosure.

Please refer to FIG. 1 to FIG. 3, the electronic device 10 (FIG. 3) of the embodiment is exemplified as a tablet computer, but the type of the electronic device 10 is not limited to this. The electronic device 10 includes an antenna module 100.

As shown in FIG. 2, in the embodiment, the antenna module 100 includes a metal cavity 110 and a feeder 120. The metal cavity 110 includes a top surface 117 and a bottom surface 118 opposite to each other, a first long side surface 111 and a second long side surface 112 opposite to each other, a first short side surface 113 and a second short side surface 114 opposite to each other, an internal space 115 and a long opening 116.

The internal space 115 is surrounded by the top surface 117, the bottom surface 118, the first long side surface 111, the second long side surface 112, the first short side surface 113, and the second short side surface 114. The long opening 116 is located at the top surface 117, the long opening 116 communicates with the internal space 115 and is close to the second long side surface 112.

In the embodiment, a length L of the metal cavity 110 is between 80 mm and 90 mm, a width W1 is between 30 mm and 40 mm, and a height H is between 2 mm and 5 mm. In the embodiment, a length of the long opening 116 is the same as the length L of the metal cavity 110. In other examples, the length of the long opening 116 may also be slightly shorter than the length L of the metal cavity 110.

As shown in FIG. 2 and FIG. 3, the feeder 120 is located in the internal space 115 and is apart from the metal cavity 110. The feeder 120 is exemplified as being formed on a plastic bracket (not shown) through an LDS process, but is not limited to this.

The feeder 120 includes a vertical section 122 and a horizontal section 124, the vertical section 122 is located above the bottom surface 118, separated from the bottom surface 118, and extends along a direction towards the top surface 117. The horizontal section 124 is located between the vertical section 122 and the top surface 117, and is separated from the top surface 117. The horizontal section 124 is parallel to the top surface 117 and the bottom surface 118.

In the embodiment, a shape of the horizontal section 124 is exemplified as rectangular, but the horizontal section 124 may also be circular or other shapes, as long as the maximum diameter is within 5 to 10 mm. The vertical section 122 of the feeder 120 is designed to be shorter, does not touch the top surface 117 and the bottom surface 118, and a length of the horizontal section 124 is designed to be larger, in order to reduce the height of the feeder 120 with this design.

As shown in FIG. 2, the feeder 120 is located between the first short side surface 112 and the second short side surface 114, and the feeder 120 is away from the long opening 116. Specifically, a distance D1 between the feeder 120 and the first short side surface 113 is equal to the distance D2 between the feeder 120 and the second short side surface 114, and a distance D3 between the feeder 120 and the second long side surface 112 is twice a distance D4 between the feeder 120 and the first long side surface 111.

In the embodiment, the antenna module 100 may resonate at a low frequency band and a high frequency band. In the embodiment, the antenna module 100 serves as a Wi-Fi 6E/7 broadband antenna architecture, with the low frequency band between 2400 MHz and 2500 MHz, and the high frequency band between 5150 MHz and 7125 MHz. Certainly, the frequency band of the antenna module 100 is not limited thereto.

The length of the long opening 116 is 0.75 times the wavelength of the low frequency band. The width W2 of the long opening 116 is between 3 mm and 7 mm. In addition, the distance D4 between the feeder 120 and the first long side surface 111 is 0.1 times the wavelength of the low frequency band, and the distance D3 between the feeder 120 and the second long side surface 112 is 0.2 times the wavelength of the low frequency band. Furthermore, as shown in FIG. 3, a distance D5 between the feeder 120 and the top surface 117 is between 0.5 mm and 1 mm.

In addition, the feeder 120 may be used to adjust and control the impedance matching and antenna performance of the high frequency band Wi-Fi 5G (5150˜5925 MHz) and Wi-Fi 6E (6925˜7125 MHz). The width W2 of the long opening 116 may be used to adjust and control the impedance matching and antenna performance of the low frequency band (2400 to 2500 MHz).

Since the antenna module 100 is an ultra-thin metal cavity antenna composed of the metal cavity 110 and the feeder 120, that is, an independent metal cavity, the antenna module 100 is less susceptible to interference from other sources such as external circuit boards, and may have good performance.

As shown in FIG. 3, the electronic device 10, in addition to the antenna module 100, further includes a screen 12, a frame area 14 located beside the screen 12, a cover plate 16 covering the screen 12 and the frame area 14, a metal cover 30, and a coaxial transmission cable 40.

The antenna module 100 is located between the metal cover 30 and the screen 12. A positive terminal of the coaxial transmission cable 40 is connected to the feeder 120, and a negative terminal of the coaxial transmission cable 40 connects the metal cavity 110 to the metal cover 30, allowing the metal cavity 110 and the metal cover 30 to be conductive with each other, resulting in a good grounding environment.

In the embodiment, a width of the frame area 14 (that is, a distance D6 in the horizontal direction between the metal of the screen and the side panel of the metal cover 30) is, for example, 5 mm, a distance D7 between the metal cavity 110 and the cover plate 16 is, for example, 3 mm, a distance D8 between the screen 12 and the metal cover 30 is, for example, 3 mm, which is the same as the height H of the metal cavity 110. The long opening 116 (FIG. 2) of the metal cavity 110 corresponds to the frame area 14. However, the dimensions are not limited thereto.

Therefore, the metal cavity 110, the metal cover 30, and the metal of the screen 12 may form an L-shaped metal cavity C, so that when the antenna module 100 transmits or receives signals, the signals will radiate upward through this long opening 116. The antenna module 100 is not easily affected by the metal cover 30 and its internal metal components, which may enhance its anti-interference capability, consequently providing internal electronic components with higher reliability and stability.

In an embodiment, the electronic device 10 further includes a speaker driver 20, the speaker driver 20 is disposed in the internal space 115 of the metal cavity 110, so that the metal cavity 110 may simultaneously serve as an antenna signal resonance cavity and a speaker, which saves space considerably.

On the other hand, if multiple antenna modules 100 are used in the electronic device 10, taking 2×2 MIMO multiple antennas as an example, they may be placed closely in parallel or vertically orthogonal to each other. There is no need to add decoupling elements between these antenna modules 100. The antenna module 100, the metal of the screen 12, and the metal cover 30 are tightly fitted together, which may provide ultra-high isolation performance.

Through experiments, when two antenna modules 100 are placed horizontally with an adjacent distance of 0 mm, the isolation is at least 15 dB, and when two antenna modules 100 are placed vertically with an orthogonal adjacent distance of 0 mm, the isolation is at least 25 dB or above, demonstrating good performance.

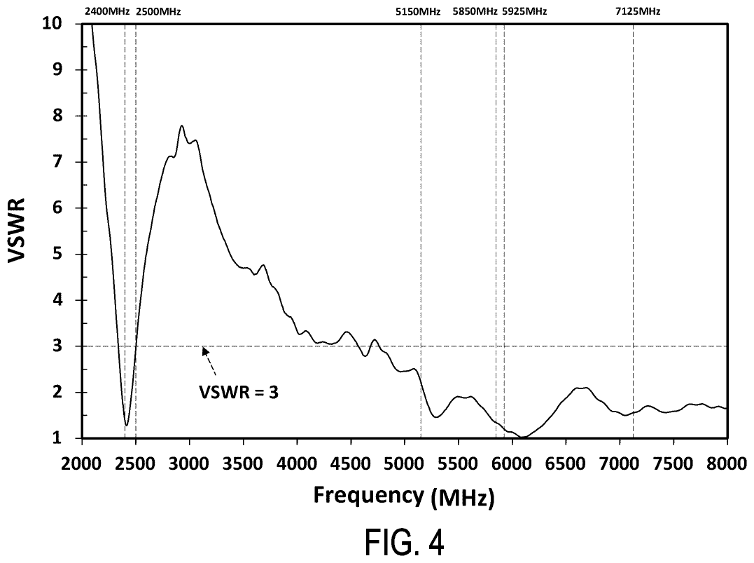

FIG. 4 is a frequency-VSWR relationship diagram of the electronic device of FIG. 3. Referring to FIG. 4, the VSWR of the antenna module 100 in the low frequency band (2400 MHz to 2500 MHz) and high frequency band (5150 MHz to 7125 MHz) may be below 3, demonstrating good performance.

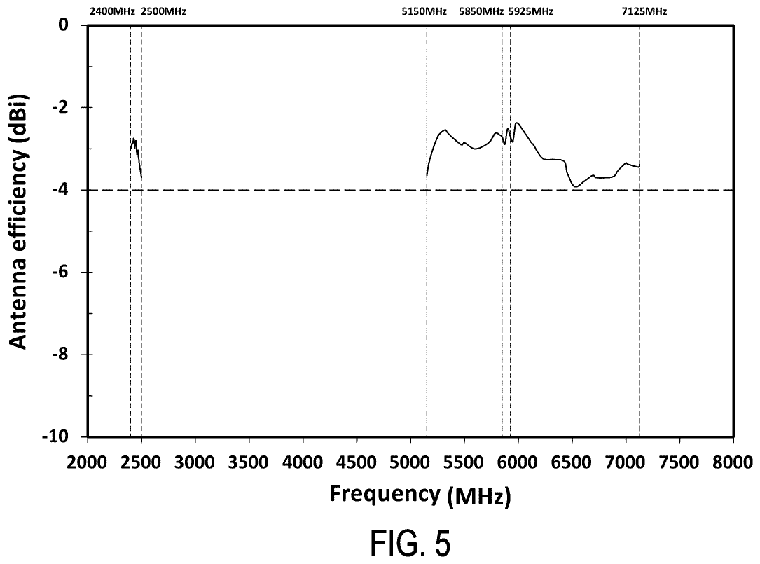

FIG. 5 is a frequency-antenna efficiency relationship diagram of the electronic device of FIG. 3. Referring to FIG. 5, the antenna module 100 has antenna efficiency above −4 dBi in both the low frequency band (2400 MHz to 2500 MHz) and high frequency band (5150 MHz to 7125 MHz).

Therefore, the antenna module 100 of the embodiment may have wide bandwidth and good antenna efficiency characteristics in a full metal cavity 110 environment, and the maximum antenna gains of the low frequency band and high frequency band can respectively meet the requirements of less than 6 dBi and 8 dBi for the module card (not shown).

In summary, the antenna module 100 of the electronic device 10 of the disclosure includes a metal cavity 110 and a feeder 120. The feeder 120 is located in the internal space 115 of the metal cavity 110 and is apart from the metal cavity 110. The distance between the feeder 120 and the first short side face 113 of the metal cavity 110 is equal to the distance between the feeder 120 and the second short side face 114 of the metal cavity 110, and the distance between the feeder 120 and the second long side face 112 of the metal cavity 110 is twice the distance between the feeder 120 and the first long side face 111 of the metal cavity 110. The metal cavity 110 includes a long opening 116 near the second long side face 112. This design not only allows the antenna module 100 to resonate at the low frequency band and high frequency band, but also allows the energy of the antenna module 100 to be transmitted from the long opening 116 and concentrated in a specific direction of radiation, providing good antenna performance.

What is claimed is:

1. An electronic device, comprising:
an antenna module, comprising:
a metal cavity, comprising a first long side surface and a second long side surface opposite to each other, a first short side surface and a second short side surface opposite to each other, an internal space and a long opening communicating with the internal space and close to the second long side surface; and
a feeder, located in the internal space and apart from the metal cavity, wherein the feeder is located between the first short side surface and the second short side surface, the feeder is away from the long opening, and the antenna module resonates at a low frequency band and a high frequency band.

2. The electronic device as claimed in claim 1, wherein a length of the long opening is 0.75 times wavelength of the low frequency band.

3. The electronic device as claimed in claim 1, wherein a width of the long opening is between 3 mm and 7 mm.

4. The electronic device as claimed in claim 1, wherein a distance between the feeder and the first short side surface is equal to a distance between the feeder and the second short side surface, and a distance between the feeder and the second long side surface is twice a distance between the feeder and the first long side surface.

5. The electronic device as claimed in claim 4, wherein the distance between the feeder and the first long side surface is 0.1 times wavelength of the low frequency band, the distance between the feeder and the second long side surface is 0.2 times wavelength of the low frequency band.

6. The electronic device as claimed in claim 1, wherein the metal cavity includes a top surface, the long opening is located at the top surface, a distance between the feeder and the top surface is between 0.5 mm and 1 mm.

7. The electronic device as claimed in claim 1, wherein the metal cavity includes a top surface and a bottom surface, the feeder includes a vertical section and a horizontal section, the vertical section is located above the bottom surface and extends along a direction toward the top surface, the horizontal section is located between the vertical section and the top surface, and is separated from the top surface.

8. The electronic device as claimed in claim 1, further comprising a screen and a frame area located beside the screen, wherein the long opening corresponds to the frame area.

9. The electronic device as claimed in claim 1, further comprising a speaker driver, located in the internal space, so that the metal cavity simultaneously serves as an antenna signal resonance cavity and a speaker.

10. The electronic device as claimed in claim 1, further comprising a metal cover and a coaxial transmission cable, wherein the antenna module is located within the metal cover, a positive terminal of the coaxial transmission cable is connected to the feeder, a negative terminal of the coaxial transmission cable connects the metal cavity to the metal cover.
